(19) United States
(12) Patent Application Publication
(10) Pub. No.: US 2024/0351479 A1
(43) Pub. Date: Oct. 24, 2024

(54) METHOD FOR PLANNING THE VEHICLE UTILIZATION OF A VEHICLE

(71) Applicant: Daimler Truck AG, Leinfelden Echterdingen (DE)

(72) Inventors: Ottmar GEHRING, Magstadt (DE); Christof BUNZ, Esslingen (DE); Luisa LANGENBACHER, Stuttgart (DE)

(21) Appl. No.: 18/685,699

(22) PCT Filed: Aug. 4, 2022
(86) PCT No.: PCT/EP2022/072024

§ 371 Date: Feb. 22, 2024

(30) Foreign Application Priority Data
Aug. 23, 2021 (DE) 10 2021 004 308.1

(51) Int. Cl. B60L 58/34; B60L 50/75; F17C 13/00

(52) U.S. Cl. CPC B60L 58/34; B60L 50/75; F17C 13/001; B60L 2200/00; B60L 2240/425

(57) ABSTRACT

The invention pertains to a method for planning a vehicle utilization of a vehicle (1), wherein at least one vehicle component is preconditioned during the vehicle utilization. The invention is characterized in that a point in time, a duration and/or a number of vehicle downtimes to be carried out during vehicle utilization are selected such that at least one traction battery (2) of the vehicle (1) has a charging status within a defined state of charging status area (3) at the beginning of a vehicle downtime, so that an amount of electrical energy provided by a boil-off management system during the vehicle downtime is stored completely in the traction battery (2) or is stored partially in the traction battery (2) and consumed completely by a third-party consumer (4) during the vehicle downtime, and an amount of electrical energy available in the traction battery (2) at the beginning of the vehicle downtime is sufficient to heat a fuel cell system (5) of the vehicle (1) to an operating temperature at the end of the vehicle downtime.

The invention pertains to a method for planning a vehicle utilization of a vehicle of the type defined in more detail in the general term of claim 1 and to a vehicle of the type defined in more detail in the general term of claim 8.

With increasing environmental awareness and the associated stricter environmental directives, the importance of alternative drive systems for vehicles is increasing. In addition to hybrid vehicles and purely battery-electric vehicles, vehicles with a fuel cell system are also known, with the aid of which electrical drive energy is obtained by reacting a fuel gas, usually hydrogen, with an oxidizing agent, usually oxygen. Storing the fuel gas places higher demands on a tank than storing liquid fuel such as gasoline. The fuel gas is typically stored in the tank under comparatively high pressure and/or low temperatures in order to be able to carry a sufficient fuel reserve with the vehicle. A corresponding fuel tank is therefore designed with thick walls and/or is thermally insulated. The thermal insulation prevents the fuel tank from heating up too quickly, which causes liquid fuel gas to evaporate and the internal tank pressure to rise too quickly.

Typically, hydrogen is stored in such a tank at around −250° in liquid form. If a vehicle with such a tank is parked for a longer period of time, the tank slowly warms up, causing liquid hydrogen to evaporate and leading to an increase in pressure in the tank. If the internal pressure in the tank rises to a critical value, hydrogen must be removed from the tank in order to reduce the pressure in the tank again. The extracted hydrogen can be released into the environment via a catalytic converter or reacted in a fuel cell system of the vehicle to form water, thereby generating electrical energy. Such a process, which leads to a thermally induced increase in pressure, is also known as boil-off.

At low ambient temperatures, it can also happen that moisture in the fuel cell system freezes, which means that the fuel cell system cannot work properly. In this case, heat must be supplied to the fuel cell system in order to thaw the frozen water again. This requires energy to generate the heat.

A cryogenic tank system for cryogenically stored fuel is known, for example, from DE 103 04 165 A1. In the boil-off case, fuel gas to be drained from the cryogenic tank system is reacted and converted into electrical energy with the aid of two recyclers, also known as a boil-off management system. Such a recycler can be a burner, a catalytic burner, a fuel cell or an internal combustion motor, for example. For safety reasons, the cryogenic tank system has at least two such recyclers, which are connected to the cryogenic tank system via a common supply line. A switch valve is provided in the supply line, which switches without auxiliary energy in order to divide the fuel gas drained from the cryogenic tank system between the recyclers. If one of the recyclers fails, safe and reliable switching is ensured so that the fuel gas to be recycled can be fed to the remaining recycler.

Furthermore, US 2018/0334170 A1 discloses a method for preconditioning a hybrid electric vehicle. In addition to a combustion motor, such a hybrid electric vehicle also comprises at least one traction battery. According to the method disclosed in the publication, heat is supplied to the traction battery, the internal combustion motor, an exhaust gas after-treatment system and/or a vehicle cabin of the vehicle in order to heat the corresponding components to an operating temperature. A traction battery heated to operating temperature is particularly energy-efficient. A combustion motor and/or exhaust gas after-treatment system warmed up to operating temperature can be operated in a particularly low-emission operating mode. A warmed-up driver's cab ensures a high level of thermal comfort for the person driving the vehicle in cold ambient conditions. The heat is supplied to the relevant components shortly before the vehicle starts and drives off. The moment at which the vehicle begins its journey is determined by analyzing user behavior and/or evaluating sensor data. The energy required to produce the heat is taken in the form of electrical energy from a traction battery of the vehicle and/or a charging station connected to the vehicle by cable. If no charging station is connected to the vehicle and the traction battery only has a comparatively low charge level, the system prioritizes which of the vehicle components should be heated and which should not be heated. There is therefore a risk that individual vehicle components cannot be sufficiently warmed up in certain situations. The vehicle can also comprise a fuel cell system according to the publication.

The present invention serves to provide a method for planning the vehicle utilization of a vehicle, which helps to minimize the loss of energy when parking a vehicle supplied with electric drive energy by a fuel cell system and allows the vehicle to be started reliably at ambient temperatures around freezing point.

According to the invention, this task is solved by a method for planning the vehicle utilization of a vehicle with the features of claim 1 and a vehicle with the features of claim 8. Advantageous embodiments and further embodiments result from the claims dependent thereon.

In a method for planning a vehicle utilization of a vehicle of the type mentioned at the beginning, at least one vehicle component is preconditioned during the vehicle utilization. According to the invention, a point in time, a duration and/or a number of vehicle downtimes to be carried out during a vehicle utilization is selected such that at least one traction battery of the vehicle has a charging status within a defined charging status area at the beginning of a vehicle downtime, so that an amount of electrical energy provided by a boil-off management system during the vehicle downtime is stored completely in the traction battery or is stored partially in the traction battery and consumed completely by a third-party consumer during the vehicle downtime, and an amount of electrical energy available in the traction battery at the beginning of the vehicle downtime is sufficient to heat a fuel cell system of the vehicle to an operating temperature at the end of the vehicle downtime.

The method according to the invention enables particularly energy-efficient and reliable operation of the vehicle. In the event of a boil-off, all the hydrogen taken from a hydrogen tank in the vehicle can be converted into electrical energy in the fuel cell system and stored in the traction battery or used by a third-party consumer. This prevents hydrogen from having to be released unused into the environment. It also ensures that sufficient electrical energy is stored in the vehicle's traction battery at the end of a vehicle downtime in order to defrost a frozen fuel cell system and/or heat it up to operating temperature. This energy-efficient and reliable operation is possible thanks to the traction battery's defined charging status area. In this way, the charging status of the traction battery is coordinated with the vehicle downtimes to be carried out during vehicle utilization in accordance with the charging status area so that a sufficient charging reserve may be provided in order to absorb electrical energy or to heat up the fuel cell system.

As the capacity of the traction battery increases, the size of the charging status area also increases. In this way, more flexibility in the planning of vehicle utilization is facilitated, as more vehicle downtimes can be carried out, a vehicle downtime can also last longer, and the vehicle downtimes can also be carried out in shorter succession or at longer intervals.

An advantageous further development of the method provides for at least one of the following parameters to be taken into account when planning the vehicle utilization:
a weather forecast valid for a current and/or future location of the vehicle;
a current and/or future vehicle load;
a traffic forecast valid for at least one section of a route to be traveled by the vehicle;
a current and/or future internal tank pressure of a cryogenic tank of the vehicle;
a current and/or future cryogenic tank temperature;
a current and/or future filling quantity of a fuel gas with which the cryogenic tank is filled; and/or.
an amount of electrical energy required by a third-party consumer during a vehicle downtime.

By taking the listed parameters into account, the charging status area and the charging status of the traction battery during a vehicle downtime can be predicted even more accurately. An ambient temperature around the vehicle can be determined taking into account the weather forecast valid for the location of the vehicle. If the ambient temperature is comparatively high, the cryogenic tank also heats up more quickly, which leads to a faster increase in the internal tank pressure. This means that the boil-off management system must also be activated earlier in order to convert fuel gas taken from the cryogenic tank, in particular hydrogen, into electrical energy with the fuel cell system and store it in the vehicle's traction battery. If, on the other hand, the ambient temperature is comparatively low, the boil-off is also delayed.

If the vehicle is carrying a comparatively large and therefore heavy load, the vehicle's consumption will also increase. As a result, the charge level of the vehicle's traction battery decreases more quickly when driving a fixed distance, which means that the lower end of the charging status area is also reached more quickly.

Similarly, the vehicle's fuel consumption increases in the event of traffic obstructions such as traffic jams or slow-moving traffic.

By monitoring the current and/or future internal tank pressure of the cryogenic tank, it is possible to predict more reliably a point in time at which a boil-off event occurs and fuel gas will need to be removed from the cryogenic tank. For example, if the internal tank pressure of the cryogenic tank is closer to its upper load limit at the beginning of a vehicle downtime, fuel gas must be removed from the cryogenic tank earlier. If, on the other hand, the internal tank pressure is comparatively low, the boil-off time is also delayed. Taking into account the parameters listed, vehicle downtimes can also be planned during which no boil-off occurs.

As the internal tank pressure also depends on the fuel gas filling quantity and the cryogenic tank temperature, the point in time at which a boil-off occurs can be determined even more reliably by monitoring the cryogenic tank temperature and the filling quantity of the cryogenic tank.

If it is to be expected that a third-party consumer must be supplied with an amount of electrical energy during a vehicle downtime, for example a crane truck, a refuse compactor, a refrigeration system, a concrete mixer or similar, the electrical energy provided by the boil-off management system can not only be stored in the traction battery but also consumed by the third-party consumer. This means that the time it takes for the traction battery to be fully charged from a defined charge level increases in comparison to charging the traction battery without the third-party consumer. In other words, simultaneous operation of a third-party consumer allows an upper limit of the charging status area to be shifted upwards in the direction of a fully charged traction battery.

According to a further advantageous embodiment of the method, vehicle utilization is planned such that the charging status of the at least one traction battery coincides with an upper or lower limit of the charging status area at the beginning of a vehicle downtime. In order to ensure that the charging status of the traction battery is within the charging status area at the start of a vehicle downtime, the vehicle's operating mode may have to be adjusted in good time before the vehicle downtime is reached. If the charging status is set such that it is at an upper or lower limit of the charging status area at the start of the vehicle downtime, the point in time at which the vehicle's operating mode needs to be adjusted can be delayed. This means that the vehicle can be operated for as long as possible during the journey, taking other optimization parameters into account.

In this way, the vehicle can be operated in a particularly fuel-efficient, cost-optimized, service life-optimized, performance-optimized or other optimal manner during the journey. This means that more degrees of freedom can be used when selecting an operating strategy for the vehicle, and therefore also for the vehicle's fuel cell system, while driving.

In order to adapt the operating mode of the vehicle so that the charging status of the traction battery is within the charging status area at the start of a vehicle downtime:
if the charging status of the traction battery is too low, the power output from the fuel cell system is increased and/or more electrical energy recovered during recuperation phases that occur while driving is stored in the traction battery. A positive side effect of increased fuel cell system output is a reduction in the internal tank pressure of the cryogenic tank;
if the charging status is too high, the fuel cell system output is reduced and the energy required to power the vehicle and/or a third-party consumer is taken from the traction battery. In addition, the cooling power of the cryogenic tank can be increased or the thermal output supplied to the cryogenic tank can be reduced in order to prevent the cryogenic tank from heating up too quickly. If the cryogenic tank is actively cooled, excess electrical energy can also be consumed by an appropriate cooling unit;
if the internal tank pressure is too high, the heat supply to the cryogenic tank is reduced, the cooling power of the cryogenic tank is increased and/or the fuel cell system output is increased;
a comparatively high charging status of the traction battery and/or a comparatively high internal tank pressure is set in the event of a comparatively high expected electrical energy requirement of a third-party consumer during a vehicle downtime.

A further advantageous embodiment of the method also provides for the planning of vehicle utilization to be carried out internally or externally to the vehicle. In order to plan the vehicle utilization, an authorized person, for example a person in charge of the vehicle or a coordinator of a vehicle fleet, can enter a corresponding journey to be carried out with the vehicle into a computing unit for evaluation. Any program suitable for evaluating the journey or for planning the vehicle utilization can be executed on the computing unit. The computing unit can, for example, be an internal or external computing unit. An in-vehicle computing unit can be, for example, a central on-board computer, a telematics unit, a control unit of a vehicle subsystem or the like. An in-vehicle computing unit can also be a mobile terminal device transported with the vehicle, such as a laptop, tablet computer, smartphone or the like. For example, a cloud server or backend can be used as an external computing unit. In addition to a planned route, any breaks to be taken and idle times are also taken into account.

This makes it possible to predict how much fuel the vehicle will consume during the journey and therefore how full the cryogenic tank will be at the start of a vehicle downtime. By simultaneously taking into account the resulting internal tank pressure and the temperature of the cryogenic tank, the point in time at which a boil-off occurs can be predicted with specific accuracy. In addition, a point in time at which the operating strategy of the vehicle is changed can be planned such that the charge level of the traction battery at the beginning of a corresponding vehicle downtime is particularly reliably within the charging status area.

According to a further advantageous embodiment of the method according to the invention, the vehicle-external planning of the vehicle utilization is carried out by a service provider. The service provider may be, for example, a vehicle manufacturer, a freight forwarder, a construction company, a public authority or the like. In particular, the service provider coordinates a vehicle fleet centrally. Corresponding fleet vehicles are in communication with a vehicle control center via a wireless communication connection, for example via mobile radio, WiFi, Bluetooth, NFC or the like. Communication can also take place via the Internet, at least in sections. Individual sections of a journey to be carried out with a vehicle can also be planned and analyzed in the vehicle itself and other sections can be planned and analyzed outside the vehicle by the service provider.

In particular, the service provider can evaluate data obtained with the vehicle fleet and thus improve the accuracy of the prediction of estimated values such as fuel consumption, the internal tank pressure at the beginning of a vehicle downtime, the charging status of the traction battery or the like.

A further advantageous embodiment of the method also provides that, before the start of a vehicle downtime, a fuel gas consumption is increased compared to a normal operating mode and/or a heating power for thermal conditioning of the cryogenic tank is reduced compared to the normal operating mode or a cooling power for thermal conditioning of the cryogenic tank is increased compared to the normal operating mode in order to set the internal tank pressure of the cryogenic tank to a lowest adjustable pressure. By minimizing the internal tank pressure at the beginning of a vehicle downtime, the duration until a boil-off occurs is increased. In this way, the internal tank pressure can be reduced by removing a particularly large amount of fuel gas from the cryogenic tank and/or cooling the cryogenic tank. The cryogenic tank can be cooled down by actively cooling the cryogenic tank or reducing the heating power to heat the cryogenic tank. Preferably, the power of the fuel cell system is increased before it comes to the vehicle downtime and the electrical energy gained from this is used to actively cool the cryogenic tank. This allows the internal tank pressure of the cryogenic tank to be lowered particularly quickly.

Preferably, an upper and/or lower limit of the charging status area and/or the point in time, the duration and/or the number of vehicle downtimes are redetermined at least once during vehicle utilization. During vehicle utilization, unforeseen events can take place which have a detrimental effect on the planning of the vehicle strategy, such that it may no longer be possible to maintain the charging status of the traction battery within the defined charging status area when a vehicle downtime is reached. By recalculating at least one of the aforementioned variables, vehicle utilization can be rescheduled at least for a section of vehicle utilization, which makes it possible to maintain the charging status of the traction battery within the specified charging status area again. For example, vehicle downtimes can be shifted forwards or backwards in time, their number can be increased or decreased, the duration of a vehicle downtime can be shortened or extended and/or the charging status area itself can be adjusted, for example because a larger or smaller amount of energy was or is consumed by a third-party consumer during a vehicle downtime than previously planned.

In a vehicle with at least one traction battery, a fuel cell system, a cryogenic tank, an electric drive machine and a computing unit, the traction battery, the fuel cell system, the cryogenic tank, the electric drive machine and the computing unit are set up in accordance with the invention to carry out a method described above. The vehicle can be any vehicle such as a car, truck, van, bus or even a construction machine such as a crane, excavator, concrete mixer or the like. The fuel cell system is, in particular, a PEM fuel cell system.

The vehicle is preferably designed as a utility vehicle. Utility vehicles are characterized by comparatively large dimensions and a high transportable payload. Furthermore, utility vehicles often have to cover long distances, which is difficult to achieve with a purely battery-powered vehicle, as this means that comparatively many charging stops have to be made. Utility vehicles are therefore particularly suitable for providing a fuel cell system to supply electrical drive energy. A method according to the invention is thus particularly advantageous to use for a utility vehicle.

Furthermore, such a vehicle preferably has an at least partially automated control system. It is particularly advantageous that the vehicle can be controlled fully automatically, which makes it possible to use a method according to the invention in an autonomously controlled vehicle fleet. This makes it possible, for example, to plan the use of an autonomous truck operated in a hub-to-hub operating mode in an even more environmentally friendly and reliable manner.

Further advantageous embodiments of the method according to the invention and of the vehicle also result from the exemplary embodiment, which are described in more detail below with reference to the figures.

In the drawings:

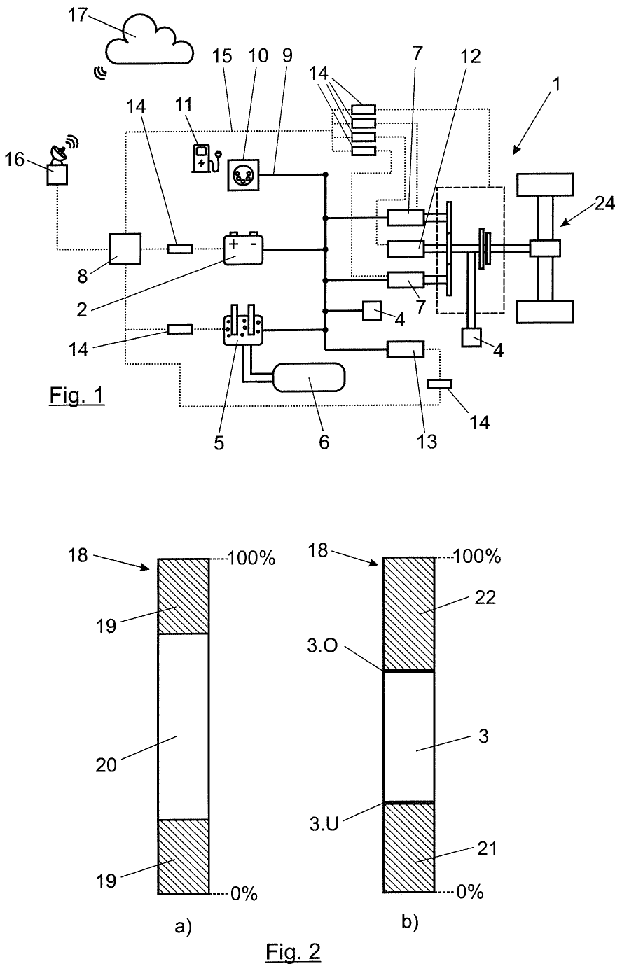

FIG. 1 a simplified schematic representation of a vehicle according to the invention;

FIG. 2 two charging status diagrams of a traction battery of the vehicle; and

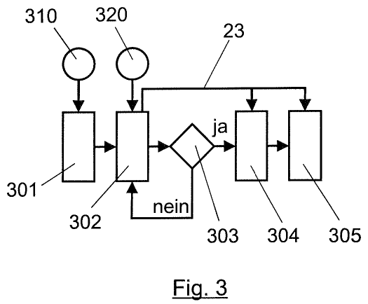

FIG. 3 a flow chart of a method according to the invention.

FIG. 1 shows a simplified schematic representation of a vehicle 1 according to the invention. The vehicle 1 may, for example, be a car, truck, bus, construction machine or the like. The vehicle 1 has at least one electric drive machine 7 for driving a drive train 24, whereby in the embodiment in FIG. 1 the vehicle 1 has two electric drive machines 7. In order to supply the electric drive machines 7 with energy, the vehicle 1 has at least one traction battery 2 and a fuel cell system 5, in particular a PEM fuel cell system. The traction battery 2, the fuel cell system 5 and the electric drive machine 7 are connected to a common high-voltage network 9 of the vehicle 1. When the vehicle 1 is stationary, the traction battery 2 can draw power from a charging station 11 via a charging interface 10. The vehicle 1 can also have further components such as a retarder 12 and/or a brake chopper 13.

The vehicle 1 also comprises at least one computing unit 8, for example a central on-board computer. In order to control and/or regulate individual vehicle components, the vehicle components are connected to the computing unit 8 via individual control units 14 via a data bus 15.

Furthermore, the vehicle 1 comprises a wireless communication interface 16, via which the vehicle 1 can exchange data with a computing unit 17 external to the vehicle, for example a cloud server. For example, the vehicle 1 can receive control commands from a vehicle control center and/or communicate a planned operation with the vehicle 1.

In order to supply the fuel cell system 5 with fuel, the fuel cell system 5 is connected to a cryogenic tank 6. A fuel gas, for example hydrogen, is stored in liquid form in the cryogenic tank 6 at a comparatively low temperature and under pressure. The cryogenic tank 6 is thermally insulated from the environment. However, since such insulation cannot completely seal the cryogenic tank 6 adiabatically from the environment, the cryogenic tank 6 heats up slowly when the vehicle 1 is parked. This causes liquid fuel gas to evaporate over time, which also causes the internal tank pressure in the cryogenic tank 6 to rise slowly. If the internal tank pressure exceeds a critical value, there is a risk that the cryogenic tank 6 will burst. In order to prevent this, fuel gas is removed from the cryogenic tank 6 and released into the environment or reacted by the fuel cell system 5, thereby generating energy.

In order to ensure that the energy obtained in this way can be fully stored in the traction battery 2 during a downtime of the vehicle 1, a charging status of the traction battery 2 at the start of a downtime must be set so low that enough buffer can be stored in the traction battery 2 to absorb the electrical energy emitted by the fuel cell system 5 when the vehicle 1 is stationary. For this purpose, the intended vehicle utilization of the vehicle 1 is planned before the start of the journey. The planning can be carried out by the vehicle-internal computing unit 8 or also by the vehicle-external computing unit 17. For this purpose, an authorized person can enter corresponding information into the respective computing units 8, 17. For this purpose, the vehicle 1 can also comprise input means not shown, such as a touchscreen or the like, or an interface for data communication with a mobile terminal device such as a laptop, tablet computer or smartphone. Such a mobile terminal device can communicate with the vehicle 1 by cable or wirelessly, for example via WiFi, Bluetooth or NFC. Furthermore, when planning the vehicle utilization, the charging status of the traction battery 2 is set such that at the end of a vehicle downtime there is still enough electrical energy in the traction battery 2 to operate a heating system of the fuel cell system 5 (not shown) for a sufficient period of time to defrost a frozen fuel cell system 5 and/or to heat it up to an operating temperature.

Furthermore, the vehicle 1 can have at least one third-party consumer 4, for example a concrete mixer, a crane, a cooling unit or the like. Vehicle utilization can be planned such that excess electrical energy generated by the fuel cell system 5 in a so-called boil-off case is not only stored in the traction battery 2, but is also used to operate the at least one third-party consumer 4. At least one of the electric drive machines 7 can also be operated to generate shaft power. All of the electrical energy generated by the fuel cell system 5 can also be used to operate the third-party consumer 4.

FIG. 2 shows two charging status diagrams 18 of the traction battery 2 in a qualitative representation. An upper end of a charging status diagram 18 corresponds to a fully charged traction battery 2, indicated by a charging status of 100%. A lower end of a charging status diagram 18 corresponds to an exhausted traction battery 2, indicated by a charging status of 0%.

FIG. 2a) shows a charging status diagram 18 during a journey with the vehicle 1. The charging status diagram 18 has two dark shaded areas 19, which represent a charge reserve for component protection. A light area 20 is used to symbolize a permissible range within which the charging status of the traction battery 2 may move during the journey. The area 20 is comparatively large, which provides comparatively many degrees of freedom for adapting an operating strategy of the vehicle 1 to different operating situations, taking into account various optimization objectives. For example, the vehicle 1 can be operated in a particularly fuel-efficient, cost-optimized, lifetime-saving, or a similar manner while driving.

FIG. 2b) shows a further charging status diagram 18 to symbolize a permissible charging status area 3 during a vehicle downtime. An operating strategy of the vehicle 1 based on the charging status area diagram 18 shown in FIG. 2b) is used to ensure that the charging status of the traction battery 2 is maintained at the beginning of a vehicle downtime within the charging status area 3 shortly before a vehicle downtime is reached.

The permissible charging status area 3 is delimited from a reserve for heating processes 21 by a lower limit 3.L and from a reserve for storing excess electrical energy 22 by an upper limit 3.U.

Ideally, the vehicle 1 is operated as late as possible before reaching a vehicle downtime in accordance with the operating strategy based on the charging status diagram 18 shown in FIG. 2b). This results in the charging status of the traction battery 2 coinciding with the upper or lower limit 3.U, 3.L at the beginning of a vehicle downtime. This allows the vehicle 1 to be operated for as long as possible in accordance with an operating strategy based on the charging status diagram 18 shown in FIG. 2a).

FIG. 3 shows a flow chart of a method according to the invention. In a method step 301, a journey to be carried out with the vehicle 1 including the associated expected vehicle downtimes is determined. Planning data 310 is used as an input variable for this purpose. The planning data 310 includes, for example, a route to be traveled by the vehicle 1, a start time, an arrival time, a number of scheduled vehicle downtimes and their duration or the like.

In a subsequent method step 302, the upper and lower limits 3.U, 3.L of the charging status area 3 are determined in order to define the permissible charging status area 3. Similarly, a point in time and/or location is determined at which the operating mode of the vehicle 1 must be adjusted before a respective vehicle downtime is reached in order to transfer the charging status of the traction battery 2 to the charging status area 3. Forecast data 320 is used as the input variable here. The forecast data 320 includes, for example, a current tank content of the cryogenic tank 6, a charging status of the traction battery 2, a load of the vehicle 1, a weather report, traffic forecast data or the like.

In method step 303, it is checked whether the point in time or location has been reached at which the vehicle 1 adjusts the operating mode so that the charging status of the traction battery 2 corresponds to the charging status area 3 when the next vehicle downtime is reached. If this is the case, the aforementioned target values are adjusted in method step 304 until the vehicle 1 is stationary. If this is not the case, however, individual target values may be recalculated by repeating method step 302. In method step 305, appropriate measures are taken in the event of a boil-off, such as activating the fuel cell system 5, switching on a third-party consumer 4, preheating the fuel cell system 5, tempering the cryogenic tank 6 or the like. According to an arrow 23 shown, strategies or target values defined for the method steps 304 and 305 can be adapted by carrying out the method step 302 again.

With the aid of the method according to the invention, it is possible to prevent fuel gas from being wasted during a vehicle downtime in order to keep the internal tank pressure of the cryogenic tank 6 within permissible limits. In addition, the reliability of the operational readiness of the vehicle 1 is improved. This ensures that sufficient battery capacity is available in a parked vehicle 1 at the end of a vehicle downtime in order to thaw a frozen fuel cell system 5 and/or heat it up to operating temperature.

1. Method for planning a vehicle utilization of a vehicle (1), wherein at least one vehicle component being preconditioned during the vehicle utilization,
characterized in that
a point in time, a duration and/or a number of vehicle downtimes to be carried out during a vehicle utilization is selected such that at least one traction battery (2) of the vehicle (1) has a charging status within a defined charging status area (3) at the beginning of a vehicle downtime, so that an amount of electrical energy provided by a boil-off management system during the vehicle downtime is stored completely in the traction battery (2) or is stored partially in the traction battery (2) and consumed completely by a third-party consumer (4) during the vehicle downtime, and an amount of electrical energy available in the traction battery (2) at the beginning of the vehicle downtime is sufficient to heat a fuel cell system (5) of the vehicle (1) to an operating temperature at the end of the vehicle downtime.

2. Method according to claim 1,
characterized in that
at least one of the following parameters is taken into account for planning the vehicle utilization:
a weather forecast valid for a current and/or future location of the vehicle (1);
a current and/or future vehicle load;
a traffic forecast valid for at least one section of a route to be traveled by the vehicle (1);
a current and/or a future internal tank pressure of a cryogenic tank (6) of the vehicle (1);
a current and/or a future cryogenic tank temperature;
a current and/or a future filling quantity of a fuel gas with which the cryogenic tank (6) is filled; and/or
an amount of electrical energy required by a third-party consumer (4) during a vehicle downtime.

3. Method according to claim 1,
characterized in that
the vehicle utilization is planned such that the charging status of the at least one traction battery (2) coincides with an upper (3.U) or lower limit (3.L) of the charging status area (3) at the beginning of a vehicle downtime.

4. Method according to claim 1,
characterized in that
the planning of the vehicle utilization takes place within the vehicle or outside the vehicle.

5. Method according to claim 4,
characterized in that
the vehicle-external planning of the vehicle utilization is carried out by a service provider.

6. Method according to claim 2,
characterized in that
before the start of a vehicle downtime, a fuel-gas consumption is increased compared to a normal operating mode and/or a heating power for thermal conditioning of the cryogenic tank (6) is reduced compared to the normal operating mode or a cooling power for thermal conditioning of the cryogenic tank (6) is increased compared to the normal operating mode in order to set the internal tank pressure of the cryogenic tank (6) to a lowest adjustable pressure.

7. Method according to claim 1,
characterized in that
an upper (3.U) and/or lower limit (3.L) of the charging status area (3) and/or the point in time, the duration and/or the number of vehicle downtimes is redetermined at least once during vehicle utilization.

8. Vehicle (1) having at least one traction battery (2), a fuel cell system (5), a cryogenic tank (6), an electric drive machine (7) and a computing unit (8),
characterized in that
the traction battery (2), the fuel cell system (5), the cryogenic tank (6), the electric drive machine (7) and the computing unit (8) are set up to carry out a method according to claim 1.

9. Vehicle (1) according to claim 8,
characterized by
a design as a utility vehicle.

10. Vehicle (1) according to claim 8,
characterized by
an at least partially automated control system.
